(19) United States
(12) Patent Application Publication
(10) Pub. No.: US 2017/0053677 A1
(43) Pub. Date: Feb. 23, 2017

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Shinsuke KAMEDA, Kanagawa (JP)

(73) Assignee: FUJI XEROX CO., LTD., Tokyo (JP)

(21) Appl. No.: 15/055,939

(22) Filed: Feb. 29, 2016

(30) Foreign Application Priority Data
Aug. 21, 2015 (JP) 2015-163302

(51) Int. Cl. G11B 27/36; G11B 27/031; G11B 27/10; G06F 3/0484

(52) U.S. Cl. CPC G11B 27/36; G06F 3/04847; G06F 3/04845; G11B 27/031; G11B 27/102

(57) ABSTRACT

An information processing apparatus includes a display controller. The display controller applies control to display an edited portion and its editing details in a moving image before or while the moving image is reproduced, in accordance with a difference obtained by comparing a pre-editing moving image and an edited moving image.

### CROSS-REFERENCE TO RELATED APPLICATIONS

This application is based on and claims priority under 35 USC 119 from Japanese Patent Application No. 2015-163302 filed Aug. 21, 2015.

### BACKGROUND

(i) Technical Field

The present invention relates to an information processing apparatus, an information processing method, and a non-transitory computer readable medium.

(ii) Related Art

Generally in editing of a moving image, a user may grasp portions of the moving image that are different before and after the editing, but the user may not be able to check what kind of editing has been done on the moving image without reproducing and comparing the different portions. Meanwhile, if a portion of the moving image that has been edited and its editing details are displayed before or while the edited moving image is reproduced, the user need not perform an operation to grasp the details in the edited portion of the moving image.

### SUMMARY

According to an aspect of the invention, there is provided an information processing apparatus including a display controller. The display controller applies control to display an edited portion and its editing details in a moving image before or while the moving image is reproduced, in accordance with a difference obtained by comparing a pre-editing moving image and an edited moving image.

### BRIEF DESCRIPTION OF THE DRAWINGS

Exemplary embodiments of the present invention will be described in detail based on the following figures, wherein:

FIG. 1 is a conceptual module diagram of an exemplary configuration according to a first exemplary embodiment;

FIG. 2 is a diagram illustrating an exemplary system configuration using the first exemplary embodiment;

FIG. 3 is a diagram illustrating a comparative example of a moving image in the case of not using the first exemplary embodiment;

FIG. 4 is a flowchart illustrating an exemplary process according to the first exemplary embodiment;

FIG. 5 is a flowchart illustrating an exemplary process according to the first exemplary embodiment;

FIG. 6 is a diagram illustrating an exemplary data structure of an edited moving image table;

FIG. 7 is a diagram illustrating an exemplary editing process;

FIG. 8 is a diagram illustrating an exemplary editing process;

FIG. 9 is a diagram illustrating an exemplary editing process;

FIG. 10 is a diagram illustrating an exemplary editing process;

FIG. 11 is a diagram illustrating an exemplary editing process;

FIG. 12 is a diagram illustrating a display example according to the first exemplary embodiment;

FIG. 13 is a diagram illustrating an exemplary process according to the first exemplary embodiment;

FIG. 14 is a diagram illustrating an exemplary data structure of a determination result table;

FIG. 15 is a diagram illustrating an exemplary data structure of a difference information table;

FIG. 16 is a flowchart illustrating an exemplary process according to the first exemplary embodiment;

FIG. 17 is a conceptual module diagram of an exemplary configuration according to a second exemplary embodiment;

FIG. 18 is a flowchart illustrating an exemplary process according to the second exemplary embodiment;

FIG. 19 is a diagram illustrating an exemplary process according to the second exemplary embodiment;

FIG. 20 is a diagram illustrating a display example according to the second exemplary embodiment;

FIG. 21 is a diagram illustrating a display example according to the second exemplary embodiment; and

FIG. 22 is a block diagram illustrating an exemplary hardware configuration of a computer implementing an exemplary embodiment.

### DETAILED DESCRIPTION

Hereinafter, various exemplary embodiments of the present invention will be described on the basis of the drawings.

### First Exemplary Embodiment

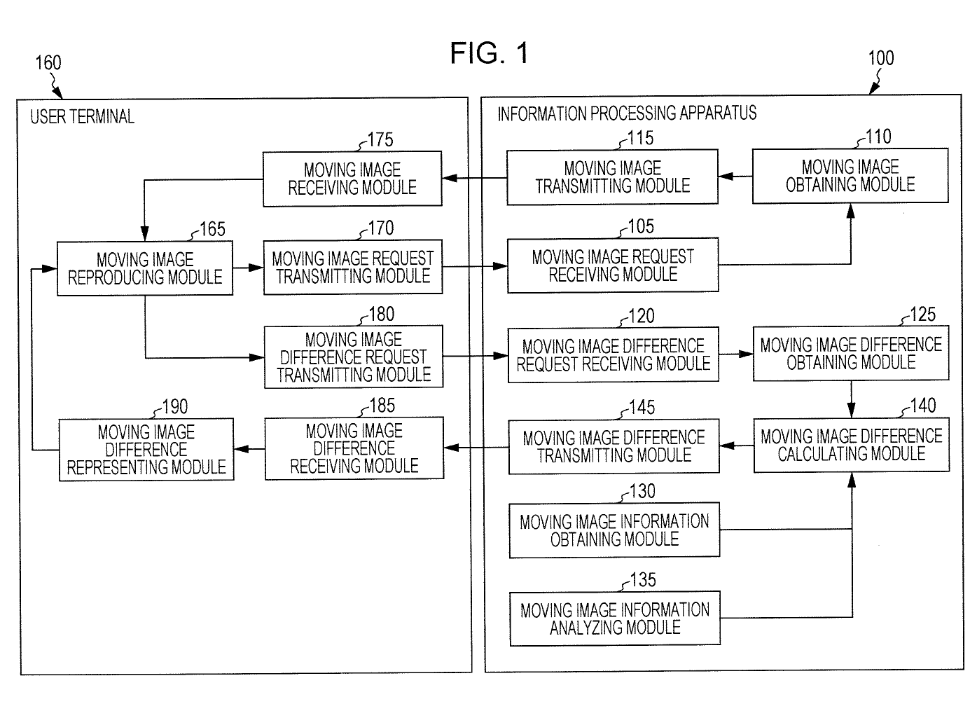

FIG. 1 is a conceptual module diagram of an exemplary configuration according to a first exemplary embodiment.

Note that the term “module” refers to components such as software (computer programs) and hardware which are typically capable of being logically separated. Consequently, the term “module” in the exemplary embodiment not only refers to modules in a computer program, but also to modules in a hardware configuration. Thus, the exemplary embodiment also serves as a description of a computer program (a program that causes a computer to execute respective operations, a program that causes a computer to function as respective units, or a program that causes a computer to implement respective functions), a system, and a method for inducing functionality as such modules. Note that although terms like “store” and “record” and their equivalents may be used in the description for the sake of convenience, these terms mean that a storage device is made to store information or that control is applied to cause a storage device to store information in the case where the exemplary embodiment is a computer program. Also, while modules may be made to correspond with function on a one-to-one basis, some implementations may be configured such that one program constitutes one module, such that one program constitutes multiple modules, or conversely, such that multiple programs constitute one module. Moreover, multiple modules may be executed by one computer, but one module may also be executed by multiple computers in a distributed or parallel computing environment. Note that a single module may also contain other modules. Also, the term “connection” may be used hereinafter to denote logical connections (such as the transfer of data and referential relationships between instructions and data) in addition to physical connections. The term “predetermined” refers to something being determined prior to the processing in question, and obviously denotes something that is determined before a process according to the exemplary embodiment starts, but may also denote something that is determined after a process according to the exemplary embodiment has started but before the processing in question, according to conditions or states at that time, or according to conditions or states up to that time. In the case of multiple “predetermined values”, the predetermined values may be respectively different values, or two or more values (this obviously also includes the case of all values) which are the same. Additionally, statements to the effect of “B is conducted in the case of A” are used to denote that a determination is made regarding whether or not A holds true, and B is conducted in the case where it is determined that A holds true. However, this excludes cases where the determination of whether or not A holds true may be omitted.

Also, the terms “system” and “device” not only encompass configurations in which multiple computers, hardware, or devices are connected by a communication medium such as a network (including connections that support a 1-to-1 communication), but also encompass configurations implemented by a single computer, hardware, or device. The terms “device” and “system” are used interchangeably. Obviously, the term “system” does not include merely artificially arranged social constructs (social systems).

Also, every time a process is conducted by each module or every time multiple processes are conducted within a module, information to be processed is retrieved from a storage device, and the processing results are written back to the storage device after the processing. Consequently, description of the retrieval from a storage device before processing and the writing back to a storage device after processing may be reduced or omitted in some cases. Note that the storage device herein may include a hard disk, random access memory (RAM), an auxiliary or external storage medium, a storage device accessed via a communication line, and a register or the like inside a central processing unit (CPU).

An information processing apparatus 100 (hereinafter may also be referred to as a server) which is a first exemplary embodiment transmits a moving image, and a user terminal 160 (may also be referred to as a client) reproduces the moving image. As illustrated in the example in FIG. 1, the information processing apparatus 100 which has the function as an image transmitting apparatus that transmits a moving image includes a moving image request receiving module 105, a moving image obtaining module 110, a moving image transmitting module 115, a moving image difference request receiving module 120, a moving image difference obtaining module 125, a moving image information obtaining module 130, a moving image information analyzing module 135, a moving image difference calculating module 140, and a moving image difference transmitting module 145. The user terminal 160 which receives and reproduces the moving image includes a moving image reproducing module 165, a moving image request transmitting module 170, a moving image receiving module 175, a moving image difference request transmitting module 180, a moving image difference receiving module 185, and a moving image difference representing module 190.

In this case, a moving image to reproduce is, for example, a moving image that may be used as an operation manual for a machine. In the case where a new function is added to the machine, as in the case where the operation method has been changed, the case may not be handled with an old moving image. In that case, the old moving image may be edited in accordance with the new function. A user who has viewed the old moving image may sometimes want to know which part of a new moving image (edited moving image) is a changed part. Note that a moving image is not limited to an operation manual for a machine, and the details of a moving image may be anything as long as the moving image has been edited (if there are both the pre-editing moving image and the edited moving image).

The information processing apparatus 100 transmits a moving image to the user terminal 160. The modules in the information processing apparatus 100 will be described hereinafter.

The moving image request receiving module 105 is connected to the moving image obtaining module 110 and to the moving image request transmitting module 170 of the user terminal 160. The moving image request receiving module 105 receives a moving image transmitting request from the user terminal 160.

The moving image obtaining module 110 is connected to the moving image request receiving module 105 and the moving image transmitting module 115. The moving image obtaining module 110 obtains a moving image that has been requested by the user terminal 160. A device from which the moving image is obtained may be a storage device in the information processing apparatus 100, or a moving image management device that manages that moving image.

The moving image transmitting module 115 is connected to the moving image obtaining module 110 and to the moving image receiving module 175 of the user terminal 160. The moving image transmitting module 115 transmits the moving image, obtained by the moving image obtaining module 110, to the user terminal 160.

The moving image difference request receiving module 120 is connected to the moving image difference obtaining module 125 and to the moving image difference request transmitting module 180 of the user terminal 160. The moving image difference request receiving module 120 receives a request from the moving image difference request transmitting module 180 (specifically, a request for the difference between a moving image in question and another moving image).

The moving image difference obtaining module 125 is connected to the moving image difference request receiving module 120 and the moving image difference calculating module 140. In response to reception of the request from the moving image difference request transmitting module 180, in order to obtain the difference between the two moving images, the moving image difference obtaining module 125 causes the moving image information obtaining module 130, the moving image information analyzing module 135, and the moving image difference calculating module 140 to perform processing.

The moving image information obtaining module 130 is connected to the moving image difference calculating module 140. The moving image information obtaining module 130 obtains information related to the moving image for which an instruction has been given from the moving image difference obtaining module 125. Here, the term “information related to the moving image” refers both to “the moving image in question” and “a pre-editing moving image of the moving image in question”, and may also include information for analysis. The moving image obtained by the moving image obtaining module 110 may be used as “the moving image in question”. If the versions of the moving image are managed, it is only necessary to extract a previous version of the moving image as “a pre-editing moving image”. In addition, for example, a bit rate, length (the amount of the moving image), and the like may be obtained as information related to the moving image.

The moving image information analyzing module 135 is connected to the moving image difference calculating module 140. On the basis of the two moving images and their information obtained by the moving image difference obtaining module 125, the moving image information analyzing module 135 analyzes the difference between the two moving images.

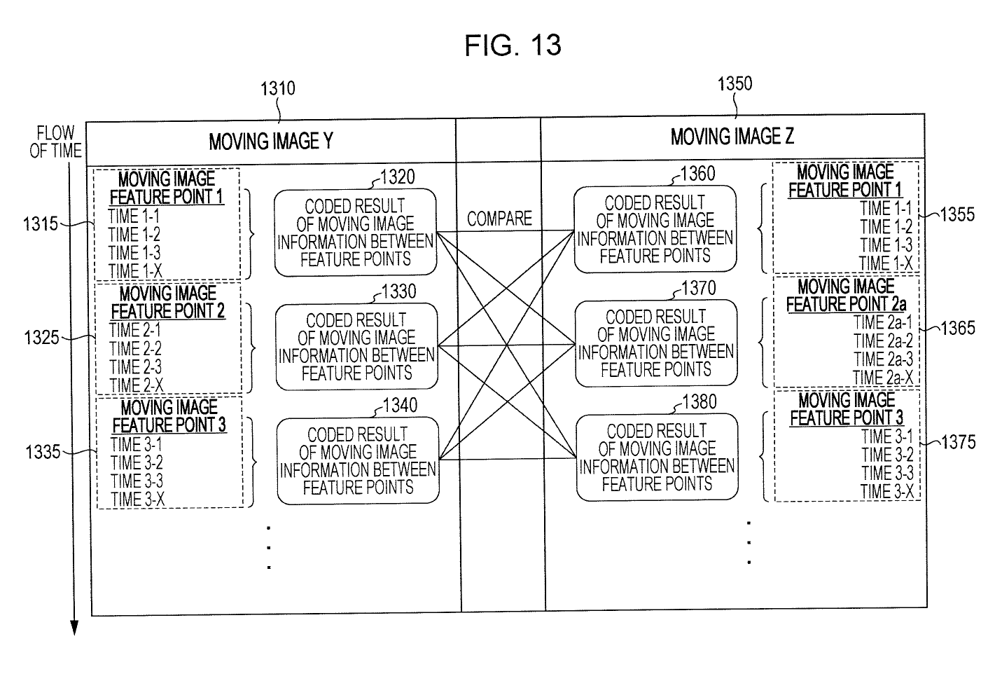

The moving image difference calculating module 140 is connected to the moving image difference obtaining module 125, the moving image information obtaining module 130, the moving image information analyzing module 135, and the moving image difference transmitting module 145. The moving image difference calculating module 140 extracts the difference on the basis of the analysis result obtained by the moving image information analyzing module 135. The difference in this case includes an edited portion and its editing details. Processing performed by the moving image information analyzing module 135 and the moving image difference calculating module 140 will be described later using the examples illustrated in FIGS. 13 to 16.

The moving image difference transmitting module 145 is connected to the moving image difference calculating module 140 and to the moving image difference receiving module 185 of the user terminal 160. The moving image difference transmitting module 145 transmits the difference, extracted by the moving image difference calculating module 140, to the moving image difference receiving module 185 of the user terminal 160.

The user terminal 160 is a terminal for a user to view a moving image and may be, for example, a personal computer (PC) or a mobile terminal. The modules in the user terminal 160 will be described hereinafter.

The moving image request transmitting module 170 is connected to the moving image reproducing module 165 and to the moving image request receiving module 105 of the information processing apparatus 100. The moving image request transmitting module 170 requests the information processing apparatus 100 to transmit a moving image. The request may be issued in response to, for example, a user operation (such as a reproducing instruction), or a predetermined time point (such as a scheduled date and time).

The moving image receiving module 175 is connected to the moving image reproducing module 165 and to the moving image transmitting module 115 of the information processing apparatus 100. The moving image receiving module 175 receives moving image data from the moving image transmitting module 115 of the information processing apparatus 100. The moving image receiving module 175 may receive at least partial moving image data.

The moving image reproducing module 165 is connected to the moving image request transmitting module 170, the moving image receiving module 175, the moving image difference request transmitting module 180, and the moving image difference representing module 190. The moving image reproducing module 165 sequentially reproduces items of data received by the moving image receiving module 175.

The moving image difference request transmitting module 180 is connected to the moving image reproducing module 165 and to the moving image difference request receiving module 120 of the information processing apparatus 100. The moving image difference request transmitting module 180 issues a request for the difference between a moving image in question and another moving image. Here, the term “a moving image in question” refers to a moving image to be reproduced or being reproduced by the moving image reproducing module 165. Also, the term “another image” refers to a moving image other than a moving image in question, and is a pre-editing moving image of the moving image in question.

The moving image difference receiving module 185 is connected to the moving image difference representing module 190 and to the moving image difference transmitting module 145 of the information processing apparatus 100. The moving image difference receiving module 185 obtains the “difference between a moving image in question and another moving image” transmitted from the information processing apparatus 100 in response to the request from the moving image difference request transmitting module 180. The difference in this case includes an edited portion and its editing details.

The moving image difference representing module 190 is connected to the moving image reproducing module 165 and the moving image difference receiving module 185. The moving image difference representing module 190 applies control to display the difference between the moving image in question and the other moving image on a screen displaying the moving image. In accordance with the difference obtained by comparing the pre-editing moving image and the edited moving image, the moving image difference representing module 190 applies control to display an edited portion and its editing details in the moving image before or while the moving image is reproduced. The expression “perform display while reproducing” refers to performing display to enable a viewer to grasp whether a portion currently being reproduced corresponds to the difference or not. For example, this may be performing such display immediately after the start of reproducing, or may be after the start of reproducing and before reproducing a frame that corresponds to the moving image difference.

The moving image difference representing module 190 may apply control, in each of frames of the moving image, to display an edited portion and its editing details in the moving image. The frames may be separated at scene transitions of the moving image or at places where video changes. Note that the expression “places where video changes” may be regarded as “places where video greatly changes”.

The moving image difference representing module 190 may compare a pre-editing frame with each of multiple edited frames, and, if there is a difference between the frames, may apply control to display that editing has been done.

The details of editing include at least one of deletion, replacement, movement, and addition.

The user terminal 160 may include the moving image difference obtaining module 125, the moving image information obtaining module 130, the moving image information analyzing module 135, and the moving image difference calculating module 140. Conversely, the information processing apparatus 100 may include the moving image difference representing module 190, and, under display control performed by the information processing apparatus 100, the user terminal 160 may display an edited portion and its editing details in the moving image.

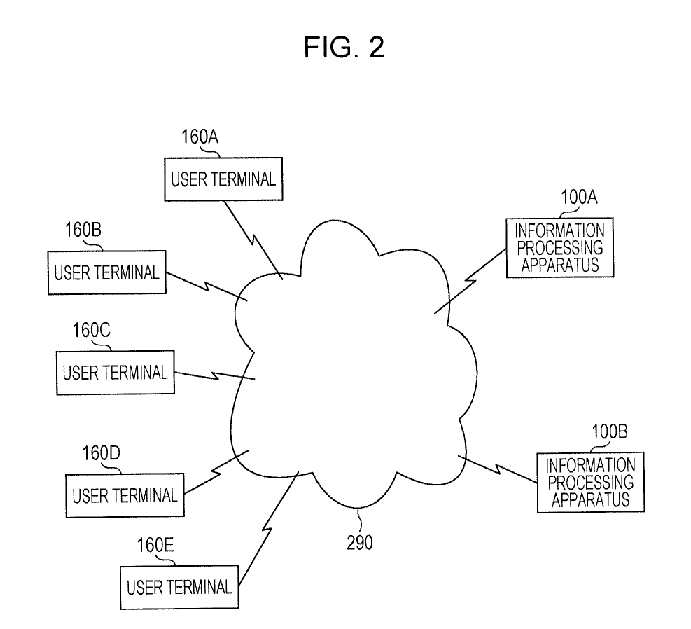

FIG. 2 is a diagram illustrating an exemplary system configuration using the first exemplary embodiment.

An information processing apparatus 100A, an information processing apparatus 100B, a user terminal 160A, a user terminal 160B, a user terminal 1600, a user terminal 160D, and a user terminal 160E are connected to one another via a communication line 290. The communication line 290 may be wireless, wired, or a combination thereof. Examples of the communication line 290 include the Internet serving as a communication infrastructure, and an intranet. The functions of the information processing apparatus 100 may be implemented as cloud services. In response to a user operation performed by the user of the user terminal 160, a moving image is transmitted from the information processing apparatus 100 and is reproduced on the user terminal 160. In that case, control is applied to display an edited portion and its editing details as the difference between the moving image being reproduced and the pre-editing moving image.

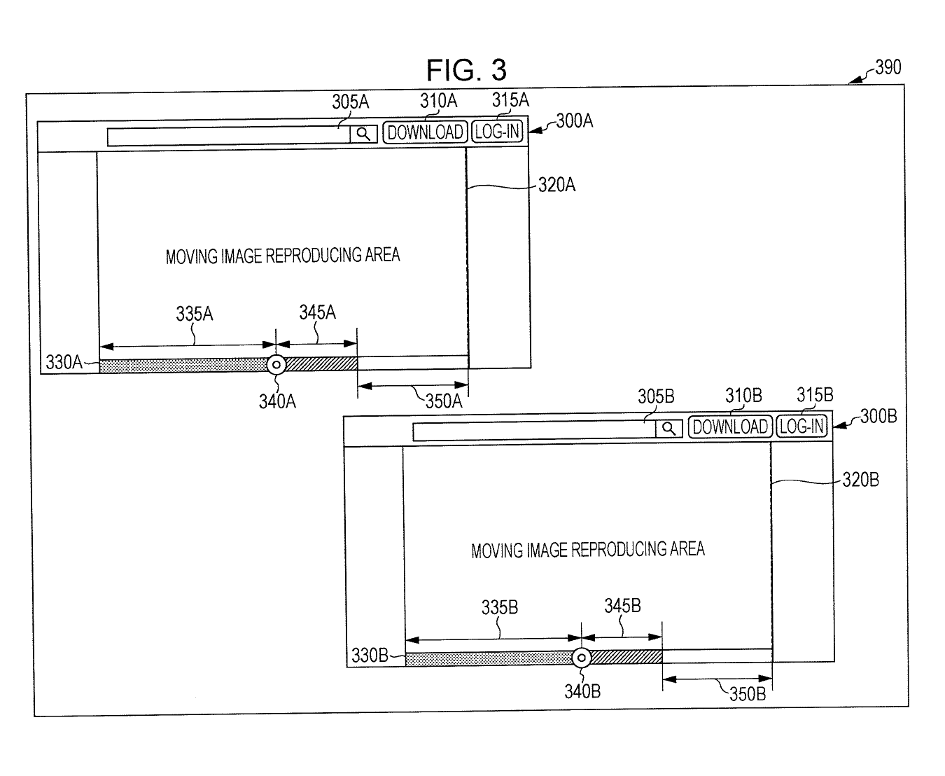

FIG. 3 is a diagram illustrating a comparative example of a moving image in the case of not using the first exemplary embodiment. Generally in the case of comparing two moving images, as illustrated in the example in FIG. 3, two screens, namely, a moving image reproducing screen 300A and a moving image reproducing screen 300B, are displayed within a screen 390. The screen 390 corresponds to a display device such as a liquid crystal display of the user terminal 160.

One moving image (such as the pre-editing moving image) is reproduced on the moving image reproducing screen 300A, and the other moving image (such as the edited moving image) is reproduced on the moving image reproducing screen 300B. In short, in order to grasp between the two moving images a portion where editing such as deletion, replacement, movement, or addition has been done, the two moving images are viewed to find the difference.

Note that the moving image reproducing screens 300A and 300B each display a search instruction area 305, a download button 310, a log-in button 315, a moving image reproducing area 320, and a reproduced amount displaying bar 330. A keyword related to a moving image to reproduce is entered in the search instruction area 305, which is used for identifying the moving image. In the case where the download button 310 is selected by a user operation, a moving image retrieved by the search is downloaded to the user terminal 160 and is started to be reproduced. In the case where the log-in button 315 is selected by a user operation, the user who has performed the operation logs in, and the user who has given the instruction to reproduce the moving image is identified. In one case, the user may operate a keyboard or the like to enter his/her user identification (ID) and password, which are then received and checked against a pre-registered user ID and password. In another case, an integrated circuit (IC) card held by the user may be read with the use of an IC card reader, and information stored in the IC card may be checked. In yet another case, biometric authentication may be performed using the user's fingerprint, for example. Alternatively, the user may be identified not from a log-in operation, but from identification information of the user terminal 160.

The reproduced amount displaying bar 330 is also called a seek bar, and indicates the position, within the entire moving image, of the moving image being displayed in the moving image reproducing area 320. In general, the left end of the reproduced amount displaying bar 330 indicates the start (beginning) of the moving image, and the right end of the reproduced amount displaying bar 330 indicates the end (termination) of the moving image. The position of a current position displaying FIG. 340 indicates the currently reproduced position. Thus, the left side of the current position displaying FIG. 340 indicates a viewed portion 335, and the right side of the current position displaying FIG. 340 generally indicates an unviewed portion. A read-ahead portion 345 indicates an amount that has been read ahead. Thus, the right side of the read-ahead portion 345 indicates an untransferred portion 350. The read-ahead portion 345 starts at the immediate right of the current position displaying FIG. 340, and its amount (the length of the read-ahead portion 345 in terms of what is displayed) is constant.

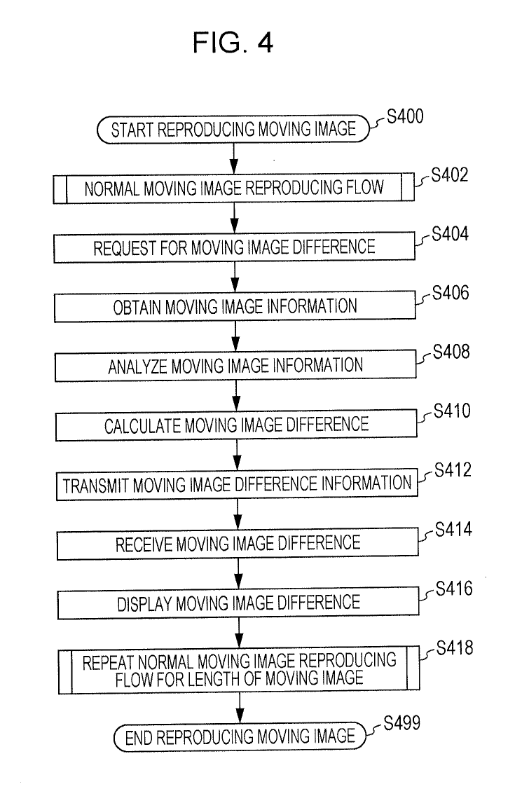

FIG. 4 is a flowchart illustrating an exemplary process according to the first exemplary embodiment.

In step S400, the process starts reproducing a moving image.

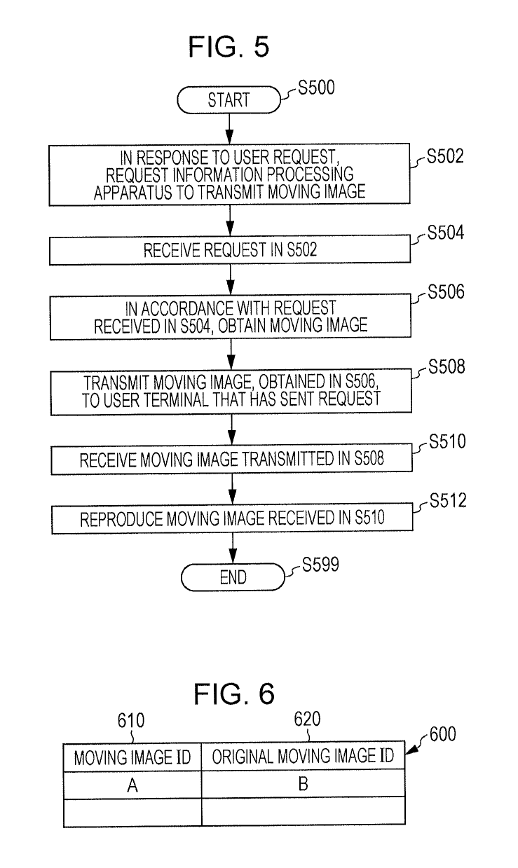

In step S402, the process performs a normal moving image reproducing flow. Details of the flow will be described later using the flowchart illustrated in the example in FIG. 5. Note that step S402 need not necessarily be performed.

In step S404, the moving image difference request transmitting module 180 issues a request for displaying a moving image difference. In short, the moving image difference request transmitting module 180 issues a request for a moving image difference while the moving image is being reproducing or before reproducing of the moving image starts (in the case where step S402 is not performed).

In accordance with this, the moving image difference request receiving module 120 receives the request for displaying a moving image difference. The moving image difference obtaining module 125 controls the moving image information obtaining module 130, the moving image information analyzing module 135, the moving image difference calculating module 140, and the moving image difference transmitting module 145 to perform the following processing (steps S406 to S412).

In step S406, the moving image information obtaining module 130 obtains information related to the moving image in question. Specifically, the moving image information obtaining module 130 obtains information related to the pre-editing moving image and the edited moving image (the moving image in question that is being reproduced). For example, the moving image information obtaining module 130 obtains the pre-editing moving image using an edited moving image table 600. The edited moving image table 600 will be described later using the example in FIG. 6.

In step S408, the moving image information analyzing module 135 analyzes the moving image information. The moving image information analyzing module 135 extracts features for comparing the two moving images.

In step S410, the moving image difference calculating module 140 calculates the difference between the moving images.

In step S412, the moving image difference transmitting module 145 transmits information indicating the difference between the moving images to the user terminal 160.

In step S414, the moving image difference receiving module 185 receives the difference between the moving images.

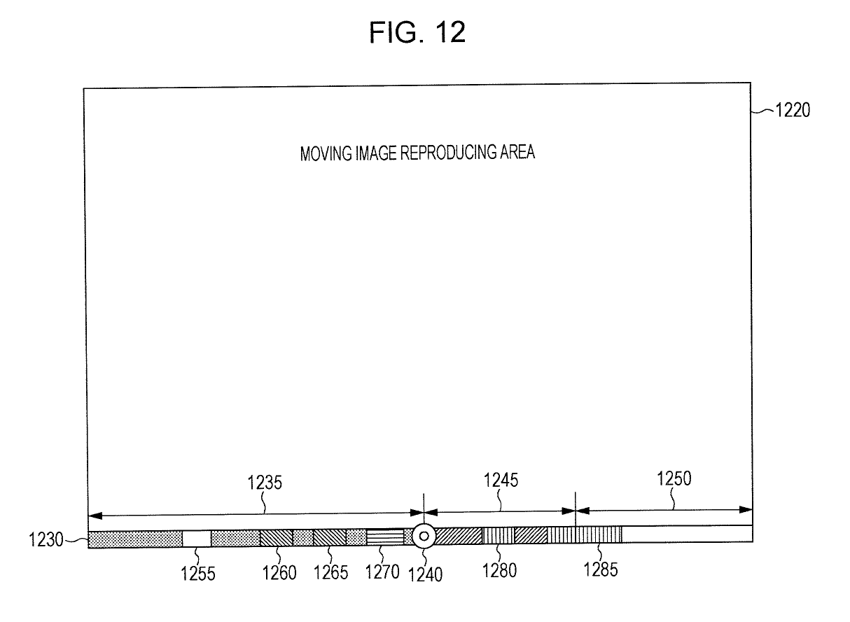

In step S416, the moving image difference representing module 190 displays the difference between the moving images. Details will be described later using the example in FIG. 12.

In step S418, the process repeats the normal moving image reproducing flow for the length of the moving image. Details of the flow will be described later using the flowchart illustrated in the example in FIG. 5.

In step S499, the process ends reproducing the moving image.

FIG. 5 is a flowchart illustrating an exemplary process according to the first exemplary embodiment.

In step S502, in response to a request from the user of the user terminal 160, the moving image request transmitting module 170 requests the information processing apparatus 100 to transmit a moving image.

In step S504, the moving image request receiving module 105 receives the request issued in step S502.

In step S506, in response to the request received in step S504, the moving image obtaining module 110 obtains the moving image.

In step S508, the moving image transmitting module 115 transmits the requested moving image, obtained in step S506, to the user terminal 160.

In step S510, the moving image receiving module 175 receives the moving image transmitted in step S508.

In step S512, the moving image reproducing module 165 reproduces the moving image received in step S510.

A specific example of the edited moving image table 600 used in step S406 will be described. FIG. 6 is a diagram illustrating an exemplary data structure of the edited moving image table 600. The edited moving image table 600 has a moving image ID column 610 and an original moving image ID column 620. The moving image ID column 610 stores information (moving image ID) for uniquely identifying a moving image in the exemplary embodiment. The original moving image ID column 620 stores a moving image ID indicating, in the case where a moving image indicated by a moving image ID in the moving image ID column 610 is an edited moving image, a pre-editing moving image.

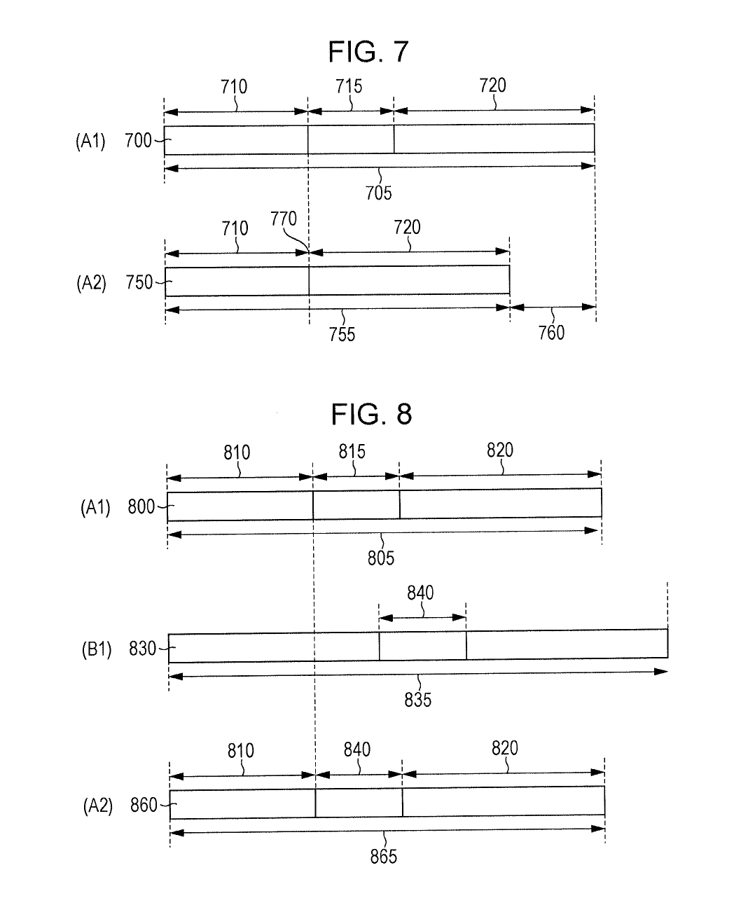

Using the examples in FIGS. 7 to 11, the details of editing (deletion, replacement, movement, and addition) will be described.

FIG. 7 is a diagram illustrating an example of an editing process (deleting process). A moving image 700 illustrated in the example in part (A1) of FIG. 7 is a pre-editing moving image, and a moving image 750 illustrated in the example in part (A2) of FIG. 7 is an edited moving image.

In response to a user operation, the start point and the end point of a to-be-deleted portion 715 are designated. Thus, the entire length 705 of the moving image 700 is divided into a front portion 710, the to-be-deleted portion 715, and a back portion 720. When the to-be-deleted portion 715 is deleted, the moving image 750 illustrated in the example in part (A2) of FIG. 7 is obtained. In short, portions of the moving image 750 before and after a deletion position 770 are the front portion 710 and the back portion 720, and the entire length 755 of the moving image 750 is a value obtained by subtracting a deletion length 760 from the entire length 705 of the moving image 700.

FIG. 8 is a diagram illustrating an example of an editing process (replacing process). A moving image 800 illustrated in the example in part (A1) of FIG. 8 is a pre-editing moving image; a moving image 830 illustrated in the example in part (B1) of FIG. 8 is a moving image different from the moving image 800; and a moving image 860 illustrated in the example in part (A2) of FIG. 8 is an edited moving image. Note that FIG. 8 illustrates an example in which, if the moving image 800 is compared with the moving image 860, it is determined that a replacing process has been performed.

The replacement in this case is replacement of a to-be-replaced portion 815 of the moving image 800 with a to-be-replaced portion 840 of the moving image 830.

In response to a user operation, the start point and the end point of the to-be-replaced portion 815 are designated. Thus, the entire length 805 of the moving image 800 is divided into a front portion 810, the to-be-replaced portion 815, and a back portion 820. The to-be-replaced portion 815 is to be replaced (to be deleted). As the other to-be-replaced portion (to-be-embedded portion), the start point and the end point of the to-be-replaced portion 840 of the moving image 830 are designated. When the replacing process is performed, the moving image 860 illustrated in the example in part (A2) of FIG. 8 is obtained. In short, the moving image 860 has the front portion 810, the to-be-replaced portion 840, and the back portion 820.

Since the length of the to-be-replaced portion 840 is the same as the length of the to-be-replaced portion 815 in the example in FIG. 8, it is determined that the to-be-replaced portion 815 has been replaced with the to-be-replaced portion 840. If a feature point is not present in the original moving image and the to-be-replaced portions have the same length, it is determined that “replacement” has been performed.

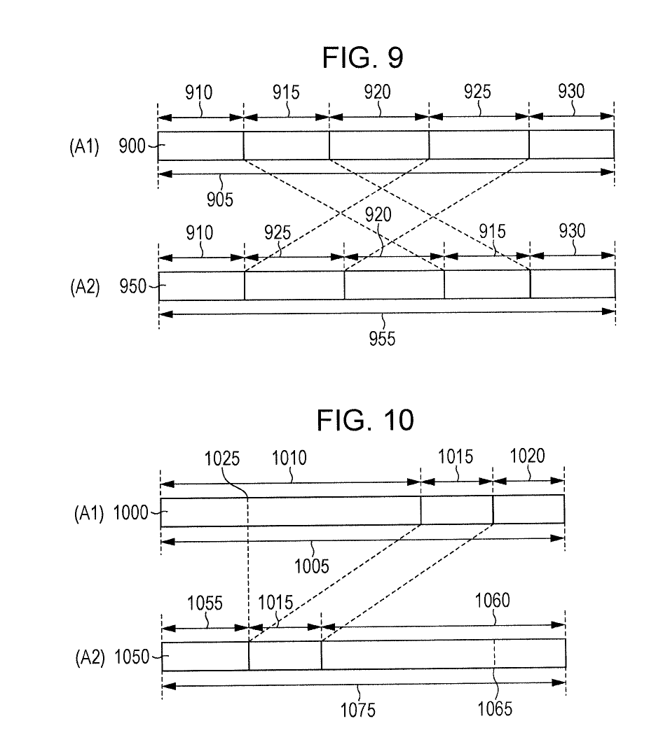

FIG. 10 is a diagram illustrating an example of an editing process (moving process). Note that the term “move” refers to a process of exchanging one portion of a moving image with another portion of the same moving image. The example illustrated in FIG. 10 indicates the case of moving one portion, and the example illustrated in FIG. 9 indicates the case of moving two portions. The example in FIG. 10 will be described first, and then the example in FIG. 9 will be described. A moving image 1000 illustrated in the example in part (A1) of FIG. 10 is a pre-editing moving image, and a moving image 1050 illustrated in the example in part (A2) of FIG. 10 is an edited moving image. The movement in this case is movement of a to-be-moved portion 1015 to the position of a movement destination 1025.

In response to a user operation, the start point and the end point of the to-be-moved portion 1015, and the position of the movement destination 1025 are designated. Thus, the entire length 1005 of the moving image 1000 is divided into a front portion 1010, the to-be-moved portion 1015, and a back portion 1020. The to-be-moved portion 1015 is to be moved. When the moving process is performed, the moving image 1050 illustrated in the example in part (A2) of FIG. 10 is obtained. In short, the moving image 1050 has a front portion 1055, the to-be-moved portion 1015, and a back portion 1060. A portion preceding a movement origin 1065 in the back portion 1060 is the same as a portion subsequent the movement destination 1025 in the front portion 1010, and a portion subsequent the movement origin 1065 is the same as the back portion 1020.

Note that the entire length 1005 of the moving image 1000 is the same as the entire length 1075 of the moving image 1050.

FIG. 9 is a diagram illustrating an example of an editing process (moving process). A moving image 900 illustrated in the example in part (A1) of FIG. 9 is a pre-editing moving image, and a moving image 950 illustrated in the example in part (A2) of FIG. 9 is an edited moving image. In the example in FIG. 9, two portions of the moving image 900 are to be moved. In short, the movement in this case replaces a to-be-moved portion 915 and a to-be-moved portion 925 of the moving image 900 with each other.

In response to a user operation, the start point and the end point of the to-be-moved portion 915 and the to-be-moved portion 925 are designated. Thus, the entire length 905 of the moving image 900 is divided into a portion 910, the to-be-moved portion 915, a portion 920, the to-be-moved portion 925, and a portion 930. The to-be-moved portion 915 and the to-be-moved portion 925 are to be moved. When the moving process is performed, the moving image 950 illustrated in the example in part (A2) of FIG. 9 is obtained. In short, the moving image 950 has the portion 910, the to-be-moved portion 925, the portion 920, the to-be-moved portion 915, and the portion 930.

Note that, in FIG. 9, the entire length 905 of the moving image 900 is the same as the entire length 955 of the moving image 950.

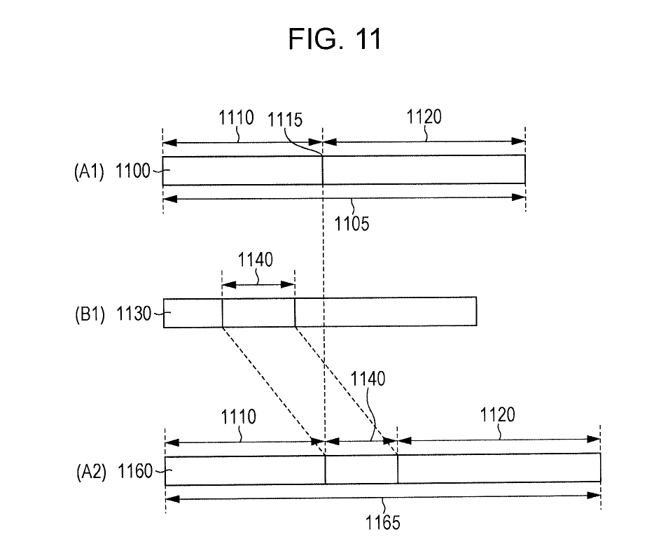

FIG. 11 is a diagram illustrating an example of an editing process (adding process). A moving image 1100 illustrated in the example in part (A1) of FIG. 11 is a pre-editing moving image; a moving image 1130 illustrated in the example in part (B1) of FIG. 11 is a moving image different from the moving image 1100; and a moving image 1160 illustrated in the example in part (A2) of FIG. 11 is an edited moving image. The addition in this case inserts a to-be-added portion 1140 of the moving image 1130 at an addition destination 1115 of the moving image 1100.

In response to a user operation, the addition destination 1115 of the moving image 1100, and the start point and the end point of the to-be-added portion 1140 of the moving image 1130 are designated. Thus, the entire length 1105 of the moving image 1100 is divided into a front portion 1110 and a back portion 1120. The to-be-added portion 1140 is to be added. When the moving process is performed, the moving image 1160 illustrated in the example in part (A2) of FIG. 11 is obtained. In short, the moving image 1160 has the front portion 1110, the to-be-added portion 1140, and the back portion 1120. The entire length 1165 of the moving image 1160 is longer by the length of the to-be-added portion 1140 than the entire length 1105 of the moving image 1100.

FIG. 12 is a diagram illustrating a display example according to the first exemplary embodiment (mainly the moving image difference representing module 190). This displays comparison between a pre-editing moving image A1 and an edited moving image A2. The edited moving image A2 is reproduced in a moving image reproducing area 1220. How the moving image A2 has changed from the moving image A1 is displayed on a reproduced amount displaying bar 1230.

The reproduced amount displaying bar 1230 displays a current position displaying FIG. 1240, like the example in FIG. 3. A deleted portion 1255, a details replaced portion 1260, a details replaced portion 1265, and a moved portion 1270 are displayed on a viewed portion 1235 of the reproduced amount displaying bar 1230, and an added portion 1280 and an added portion 1285 are displayed on a read-ahead portion 1245 and an untransferred portion 1250.

In the case of reproducing the deleted portion 1255, the moving image is reproduced as if there were no such portion. The details replaced portion 1260 and the details replaced portion 1265 are replaced with each other. The types of editing details (deletion, replacement, movement, and addition) may be displayed using different forms (colors, patterns, shapes, addition of text, or a combination thereof). Since the fact that the moving image has been edited is displayed on the reproduced amount displaying bar 1230 in accordance with the type of editing details (deletion, replacement, movement, or addition), the viewer is able to grasp what kind of editing has been done on the moving image before or while the moving image is reproduced.

FIG. 13 is a diagram illustrating an exemplary process according to the first exemplary embodiment (mainly the moving image information analyzing module 135 and the moving image difference calculating module 140). Comparison between a moving image Y 1310 and a moving image Z 1350 will be described. In the case where a pre-editing moving image is a moving image A1, an edited moving image is a moving image A2, and a moving image different from the moving images in question (the moving image A1 and the moving image A2) is a moving image B, the following combinations are possible: a combination of the moving image A1 and the moving image A2; a combination of the moving image A1 and the moving image B; and a combination of the moving image A2 and the moving image B.

The moving image Y 1310 and the moving image Z 1350 are divided. For example, each of the moving image Y 1310 and the moving image Z 1350 may be divided into portions at scene transitions of the moving image or at places where video changes, or at every predetermined period (such as every minute). A moving image feature point is extracted from each of the divided portions. A technique of the related art may be used for extracting a moving image feature point. For example, a feature extraction technique used in face image recognition or the like may be used. As a result, a moving image feature point 1315, a moving image feature point 1325, a moving image feature point 1335, and so forth are generated for each of the divided portions of the moving image Y 1310; and a moving image feature point 1355, a moving image feature point 1365, a moving image feature point 1375, and so forth are generated for each of the divided portions of the moving image Z 1350.

Moving image information between the feature points is coded to generate a coded result 1320 and so forth. For example, the results of feature extraction may be concatenated, or hashCode may be generated.

Next, the coded result 1320 and so forth of the moving image Y 1310 are compared with a coded result 1360 and so forth of the moving image Z 1350, thereby extracting matching combinations. Here, all possible combinations of the coded results (coded result 1320 and so forth) of the moving image Y 1310 and the coded results (coded result 1360 and so forth) of the moving image Z 1350 are generated, and the coded results of the individual combinations are compared with each other. If a matching combination is found, after that, existing speedup processing such as omitting comparison processing may be applied. Note that the term “matching” includes not only the case of complete matching, but also the case in which a distance indicating the difference between the two is less than or equal to a predetermined threshold. A distance indicating the difference is the distance between two items being compared, in a feature space.

Units of moving image comparison may be made more detailed (in a shorter period of time) by extracting more features or coding features at more detailed levels.

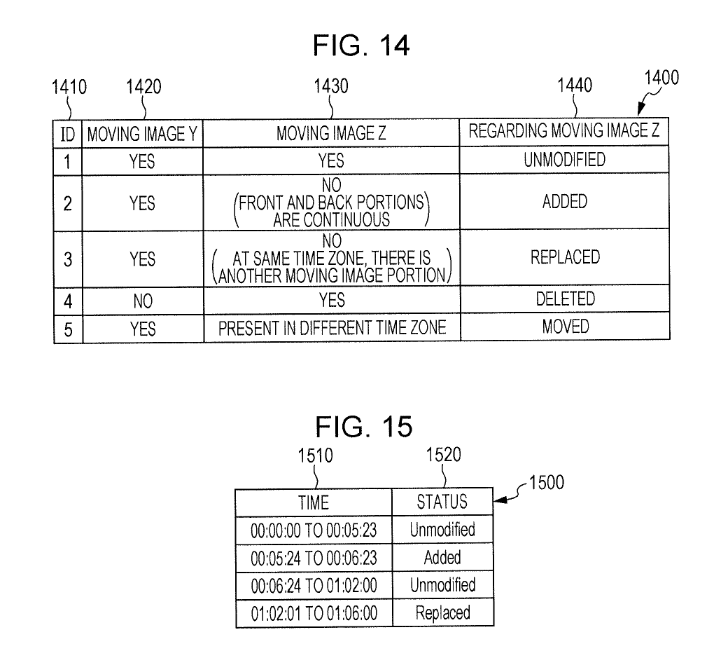

FIG. 14 is a diagram illustrating an exemplary data structure of a determination result table 1400. The determination result table 1400 indicates the results of comparison processing illustrated in the example in FIG. 13.

The determination result table 1400 has an ID column 1410, a moving image Y column 1420, a moving image Z column 1430, and a regarding moving image Z column 1440. The ID column 1410 stores identification information for uniquely identifying a portion of a moving image in the exemplary embodiment. The moving image Y column 1420 stores information indicating whether that portion of the moving image is present in a moving image Y. The moving image Z column 1430 stores information indicating whether that portion of the moving image is present in the moving image Z. The regarding moving image Z column 1440 stores processing performed on the moving image Z. “Unmodified” indicates that, as a result of comparison, it is determined that the two are identical and are in the same time zone. In short, no editing is performed in this portion. “Added” indicates that, as a result of comparison, it is determined that there is a portion that is present in the moving image Y but not in the moving image Z (portions before and after this portion are continuous in the moving image Z) (see the example in FIG. 11). In this case, it is indicated that a portion of a moving image other than the moving image Z has been “added”. “Replaced” indicates that, as a result of comparison, it is determined that there is a portion that is present in the moving image Y but not in the moving image Z (at the same time zone as a portion of the moving image Y, there is another moving image portion in the moving image Z) (see the example in FIG. 8). “Deleted” indicates that, as a result of comparison, it is determined that there is a portion that is not present in the moving image Y but is present in the moving image Z (see the example in FIG. 7). “Moved” indicates that, as a result of comparison, it is determined that a portion that matches a portion present in the moving image Y is present in another time zone in the moving image Z (see the example in FIG. 10 and the example in FIG. 9). Note that the example illustrated in FIG. 10 indicates the case of moving one portion in one moving image, and the example illustrated in FIG. 9 indicates the case of moving two portions in one moving image.

FIG. 15 is a diagram illustrating an exemplary data structure of a difference information table 1500. The difference information table 1500 indicates the result of processing performed by the moving image difference calculating module 140. Thus, the difference information table 1500 is information transmitted by the moving image difference transmitting module 145 to the user terminal 160. The moving image difference representing module 190 applies control to display items on the reproduced amount displaying bar 1230 in accordance with the difference information table 1500.

The difference information table 1500 has a time column 1510 and a status column 1520. The time column 1510 stores a time zone. The status column 1520 stores information indicating the status of a moving image portion in that time zone (the type of editing details, including the status “unmodified”).

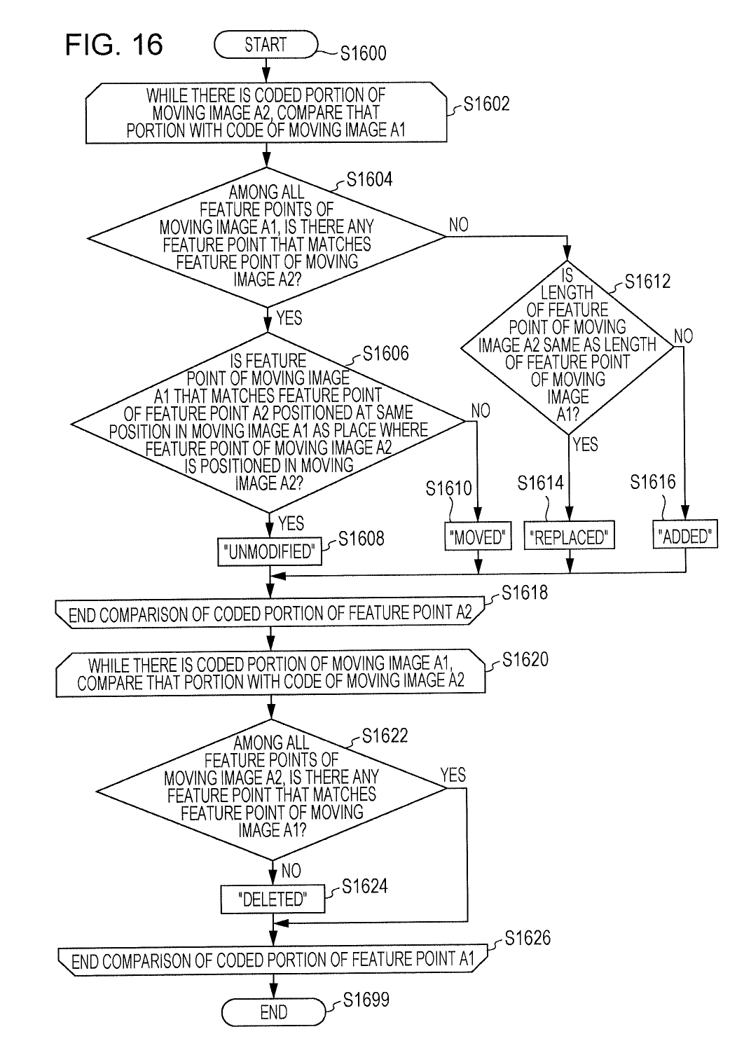

FIG. 16 is a flowchart illustrating an exemplary process according to the first exemplary embodiment.

In step S1602, while there is a coded portion of the moving image A2, the process compares that coded portion with code of the moving image A1 until step S1618. In short, the process compares a portion of the moving image A2 with the entire moving image A1.

In step S1604, the process determines whether there is, among all feature points of the moving image A1, any feature point that matches a feature point of the moving image A2. If there is such a matching feature point, the process proceeds to step S1606, and otherwise, the process proceeds to step S1612.

In step S1606, the process determines whether the feature point of the moving image A1 that matches the feature point of the moving image A2 is positioned at the same position in the moving image A1 as a place where the feature point of the moving image A2 is positioned in the moving image A2. If the feature point of the moving image A1 is positioned at the same place (time zone), the process proceeds to step S1608, and otherwise, the process proceeds to step S1610.

In step S1608, the process determines that the moving image is “unmodified”.

In step S1610, the process determines that a portion has been “moved”. As has been described above, as illustrated in the example in FIG. 9, when one portion is replaced with another in the moving image A1, the process determines negative in step S1606. However, if a portion of the moving image at the movement origin and a portion of the moving image at the movement destination that have the same time length are replaced with each other, the process may simply determine that the portions have been “replaced” with each other.

In step S1612, the process determines whether the length of the feature point of the moving image A2 is the same as the length of the feature point of the moving image A1 (the length of reproducing time). If the lengths are the same, the process proceeds to step S1614, and otherwise, the process proceeds to step S1616. Although the determination is based only on the length of the moving image A and the length of the moving image A1, if the moving image A2 has no portion that has been deleted from the moving image A1, it may be determined that addition has been done. Conversely, if the moving image A2 has a portion that has been deleted from the moving image A1, it may be determined that replacement has been done.

In step S1614, the process determines that a portion has been “replaced”.

In step S1616, the process determines that a portion has been “added”.

In step S1618, the process ends comparison of the coded portion of the moving image A2.

In step S1620, while there is a coded portion of the moving image A1, the process compares code of the moving image A1 with code of the moving image A2 until step S1626. In short, the process compares a portion of the moving image A1 with the entire moving image A2.

In step S1622, the process determines whether there is, among all feature points of the moving image A2, any feature point that matches a feature point of the moving image A1. If there is such a matching feature point, the process proceeds to step S1626, and otherwise, the process proceeds to step S1624.

In step S1624, the process determines that a portion has been “deleted”.

In step S1626, the process ends comparison of the coded portion of the moving image A1.

### Second Exemplary Embodiment

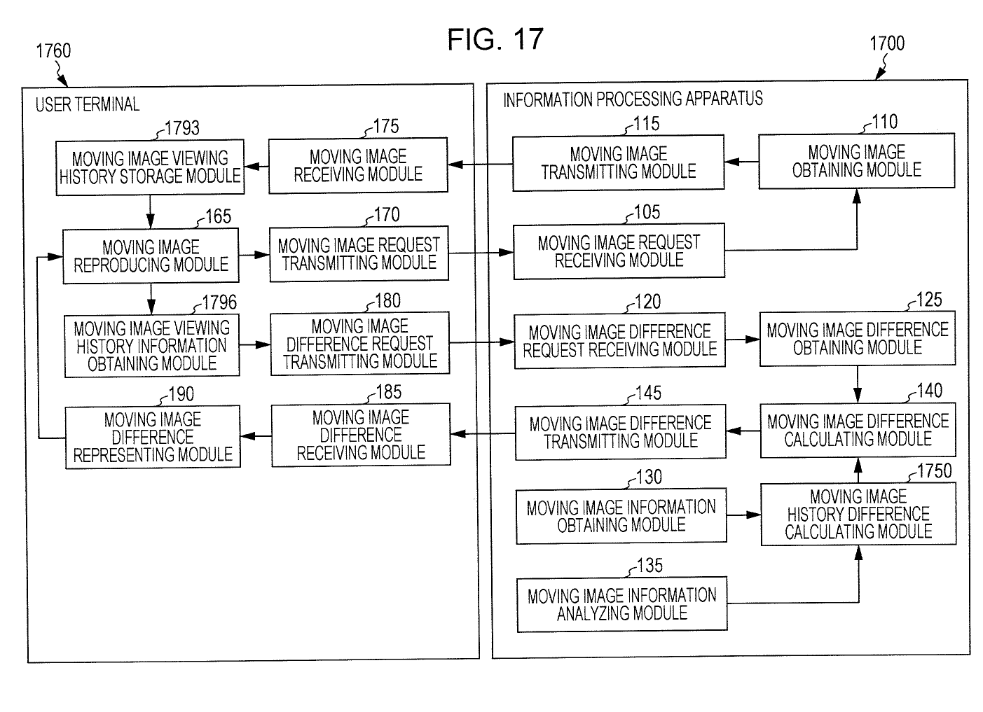

FIG. 17 is a conceptual module diagram of an exemplary configuration according to a second exemplary embodiment.

An information processing apparatus 1700 (hereinafter may also be referred to as a server) which is the second exemplary embodiment transmits a moving image, and a user terminal 1760 (may also be referred to as a client) reproduces the moving image. As illustrated in the example in FIG. 17, the information processing apparatus 1700 which has the function as an image transmitting apparatus that transmits a moving image includes the moving image request receiving module 105, the moving image obtaining module 110, the moving image transmitting module 115, the moving image difference request receiving module 120, the moving image difference obtaining module 125, the moving image information obtaining module 130, the moving image information analyzing module 135, the moving image difference calculating module 140, the moving image difference transmitting module 145, and a moving image history difference calculating module 1750. The user terminal 1760 which receives and reproduces the moving image includes the moving image reproducing module 165, the moving image request transmitting module 170, the moving image receiving module 175, the moving image difference request transmitting module 180, the moving image difference receiving module 185, the moving image difference representing module 190, a moving image viewing history storage module 1793, and a moving image viewing history information obtaining module 1796. In short, the information processing apparatus 1700 is the information processing apparatus 100 plus the moving image history difference calculating module 1750, and the user terminal 1760 is the user terminal 160 plus the moving image viewing history storage module 1793 and the moving image viewing history information obtaining module 1796. Note that the same reference numerals are given to the same portions as the above-described first exemplary embodiment, and overlapping descriptions are omitted.

In the second exemplary embodiment, in the case where there are multiple pre-editing moving images, or, using a viewing history, an edited portion and its editing details in a moving image are display-controlled.

The modules in the information processing apparatus 1700 will be described hereinafter.

The moving image request receiving module 105 is connected to the moving image obtaining module 110 and to the moving image request transmitting module 170 of the user terminal 1760.

The moving image obtaining module 110 is connected to the moving image request receiving module 105 and the moving image transmitting module 115.

The moving image transmitting module 115 is connected to the moving image obtaining module 110 and to the moving image receiving module 175 of the user terminal 1760.

The moving image difference request receiving module 120 is connected to the moving image difference obtaining module 125 and to the moving image difference request transmitting module 180 of the user terminal 1760.

The moving image difference obtaining module 125 is connected to the moving image difference request receiving module 120 and the moving image difference calculating module 140.

The moving image information obtaining module 130 is connected to the moving image history difference calculating module 1750.

The moving image information analyzing module 135 is connected to the moving image history difference calculating module 1750.

The moving image difference calculating module 140 is connected to the moving image difference obtaining module 125, the moving image history difference calculating module 1750, and the moving image difference transmitting module 145.

The moving image difference transmitting module 145 is connected to the moving image difference calculating module 140 and to the moving image difference receiving module 185 of the user terminal 1760.

The moving image history difference calculating module 1750 is connected to the moving image information obtaining module 130, the moving image information analyzing module 135, and the moving image difference calculating module 140. The moving image history difference calculating module 1750 calculates a viewed portion of a moving image.

The modules in the user terminal 1760 will be described hereinafter.

The moving image reproducing module 165 is connected to the moving image request transmitting module 170, the moving image viewing history storage module 1793, the moving image viewing history information obtaining module 1796, and the moving image difference representing module 190.

The moving image request transmitting module 170 is connected to the moving image reproducing module 165 and to the moving image request receiving module 105 of the information processing apparatus 1700.

The moving image receiving module 175 is connected to the moving image viewing history storage module 1793 and to the moving image transmitting module 115 of the information processing apparatus 1700.

The moving image difference request transmitting module 180 is connected to the moving image viewing history information obtaining module 1796 and to the moving image difference request receiving module 120 of the information processing apparatus 1700.

The moving image difference receiving module 185 is connected to the moving image difference representing module 190 and to the moving image difference transmitting module 145 of the information processing apparatus 1700.

The moving image difference representing module 190 is connected to the moving image reproducing module 165 and the moving image difference receiving module 185. In addition to processing performed by the moving image difference representing module 190 according to the first exemplary embodiment, the moving image difference representing module 190 applies control to display, in the case where there are multiple pre-editing moving images, which of the pre-editing moving images has been edited to produce an edited portion, and to display its editing details.

The moving image difference representing module 190 may compare a pre-editing moving image that has been viewed by a user in question with an edited moving image.

The moving image viewing history storage module 1793 is connected to the moving image reproducing module 165 and the moving image receiving module 175. The moving image viewing history storage module 1793 stores a history including a reproduced portion of a viewed moving image.

The moving image viewing history information obtaining module 1796 is connected to the moving image reproducing module 165 and the moving image difference request transmitting module 180. The moving image viewing history information obtaining module 1796 obtains history information of a moving image or moving images that have been viewed on the user terminal 1760.

The moving image viewing history stored in the moving image viewing history storage module 1793 or obtained by the moving image viewing history information obtaining module 1796 may be held on the information processing apparatus 1700 side in association with (in connection with) user information. If the history information is held on the user terminal 1760 side, the history information may be used without specifying the information processing apparatus 1700, which is a moving image distribution site. If the history information is held on the information processing apparatus 1700 side, since the history information is associated with the user, even when the user terminal 1760 is changed to another terminal, the history information may be used in the case of the same user ID.

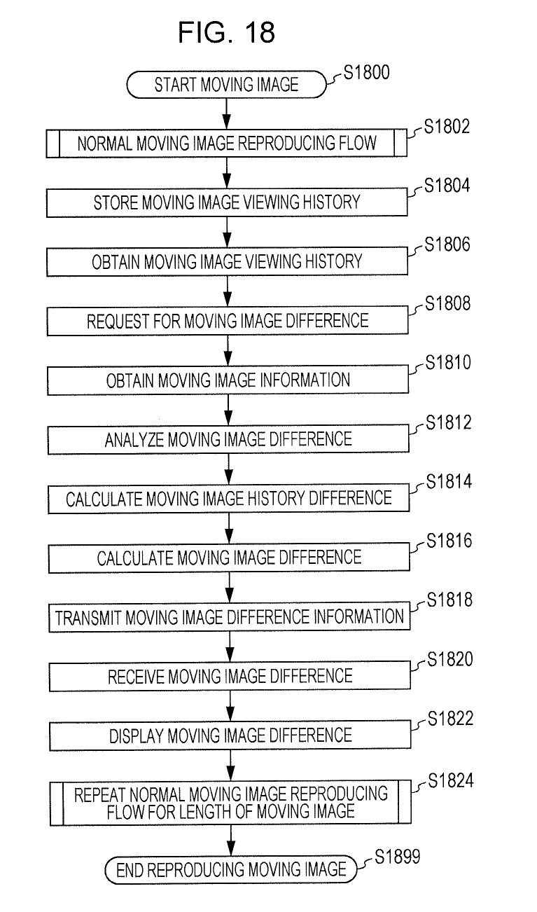

FIG. 18 is a flowchart illustrating an exemplary process according to the second exemplary embodiment. The flowchart illustrated in the example in FIG. 18 is a flowchart obtained by adding steps S1804, S1806, and S1814 to the flowchart illustrated in FIG. 4.

In step S1800, the process starts a moving image.

In step S1802, the process performs a normal moving image reproducing flow. Details of the flow have already been described using the flowchart illustrated in the example in FIG. 5. Note that step S1802 need not necessarily be performed.

In step S1804, the moving image viewing history storage module 1793 stores a moving image viewing history.

In step S1806, the moving image viewing history information obtaining module 1796 obtains a moving image viewing history.

In step S1808, the moving image difference request transmitting module 180 issues a request for a moving image difference. In short, the moving image difference request transmitting module 180 issues a request for a moving image difference while the moving image is being reproducing or before reproducing of the moving image starts (in the case where step S1802 is not performed). In that case, the process transmits the moving image viewing history obtained in step S1806.

In accordance with this, the moving image difference request receiving module 120 receives the request for a moving image difference. The moving image difference obtaining module 125 controls the moving image information obtaining module 130, the moving image information analyzing module 135, the moving image history difference calculating module 1750, the moving image difference calculating module 140, and the moving image difference transmitting module 145 to perform the following processing (steps S1810 to S1818).

In step S1810, the moving image information obtaining module 130 obtains the moving image information.

In step S1812, the moving image information analyzing module 135 analyzes the moving image information.

In step S1814, the moving image history difference calculating module 1750 calculates the difference between the moving image histories.

In step S1816, the moving image difference calculating module 140 calculates the difference between the moving images.

In step S1818, the moving image difference transmitting module 145 transmits information indicating the difference between the moving images.

In step S1820, the moving image difference receiving module 185 receives the difference between the moving images.

In step S1822, the moving image difference representing module 190 displays the difference between the moving images.

In step S1824, the process repeats the normal moving image reproducing flow for the length of the moving image. Details of the flow have already been described using the flowchart illustrated in the example in FIG. 5. Thereafter, like step S1804, the moving image viewing history storage module 1793 may store a moving image viewing history.

In step S1899, the process ends reproducing the moving image.

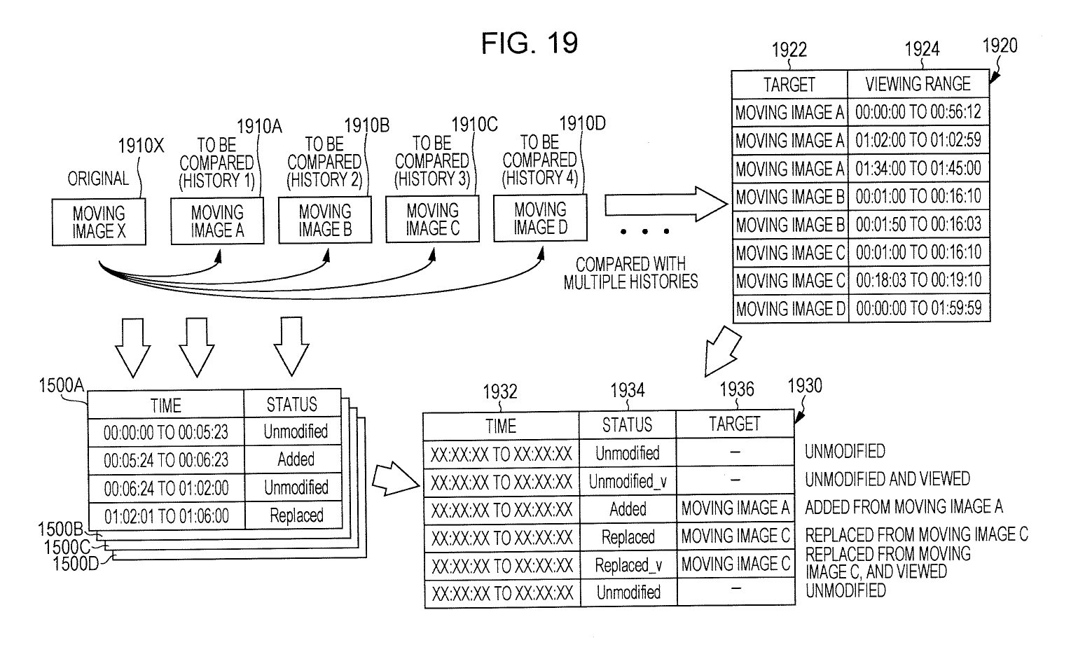

FIG. 19 is a diagram illustrating an exemplary process according to the second exemplary embodiment.

A moving image X (1910X) is a moving image to be reproduced. As moving images to be compared with the moving image X (1910X), there are multiple pre-editing moving images (a moving image A (1910A), a moving image B (1910B), a moving image C (1910C), and a moving image D (1910D)).

Each of these images is compared with the moving image X (1910X), and its difference information is generated, like the first exemplary embodiment. Thus, multiple difference information tables 1500 are generated. In the case of the example in FIG. 19, since there are four moving images to be compared, four difference information tables 1500 are generated.

In addition, the moving image history difference calculating module 1750 obtains a viewing history table 1920 of each of the moving images to be compared, via the moving image viewing history storage module 1793 and the moving image viewing history information obtaining module 1796. The viewing history table 1920 is generated for each user, and has a target column 1922 and a viewing range column 1924. The target column 1922 stores the ID of a moving image in question. The viewing range column 1924 stores a viewing range (time zone) in the history of that moving image. A moving image to be compared may be selected using the viewing history table 1920. The entirety (from the beginning to the end) of a moving image listed in the target column 1922 is not necessarily viewed. Such a moving image has a viewed portion and an unviewed portion as a result of skipped viewing.

The moving image history difference calculating module 1750 generates a difference information table 1930 using the multiple difference information tables 1500 and the viewing history table 1920. The difference information table 1930 has a time column 1932, a status column 1934, and a target column 1936. The difference information table 1930 is the difference information table 1500 illustrated in the example in FIG. 15 plus the target column 1936. The time column 1932 stores a time zone. The status column 1934 stores information indicating the status of a moving image portion in that time zone (the type of editing details, including the status “unmodified”). The target column 1936 stores the ID of a moving image to be compared. The individual lines of the difference information table 1930 indicate that a partial moving image in that time zone is “unmodified”, “unmodified and viewed”, “added from moving image A”, “replaced from moving image C”, “replaced from moving image C, and viewed”, and so forth.

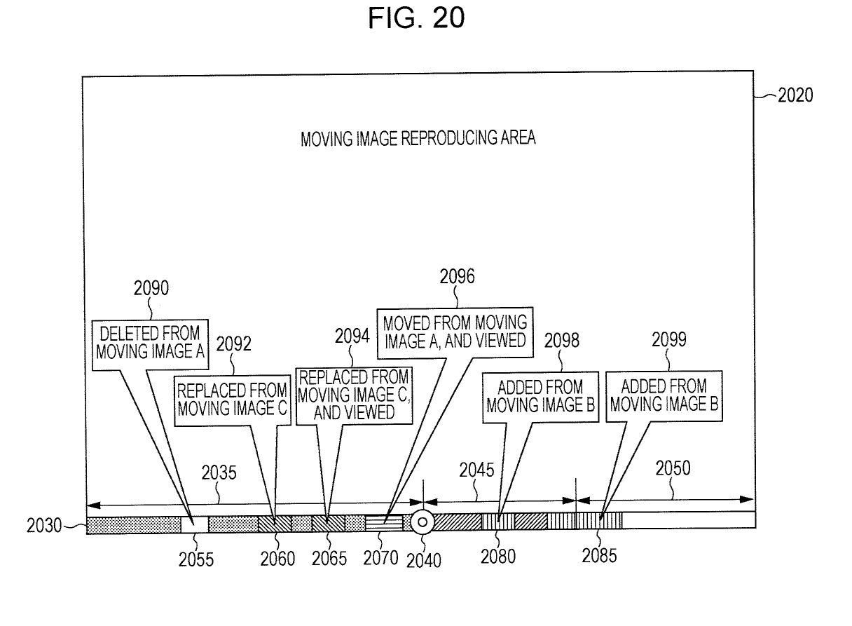

FIG. 20 is a diagram illustrating a display example according to the second exemplary embodiment (mainly the moving image difference representing module 190). This displays comparison between the multiple pre-editing moving images A to C and the edited moving image X. The edited moving image X is reproduced in a moving image reproducing area 2020. How the moving image X has changed from the moving image A and so forth is displayed on a reproduced amount displaying bar 2030.

The reproduced amount displaying bar 2030 displays a current position displaying FIG. 2040, like the example in FIG. 3. A deleted portion 2055 “deleted from moving image A: 2090”, a details replaced portion 2060 “replaced from moving image C: 2092”, a details replaced portion 2065 “replaced from moving image C and viewed: 2094”, and a moved portion 2070 “moved from moving image A and viewed: 2096” are displayed on a viewed portion 2035 of the reproduced amount displaying bar 2030. An added portion 2080 “added from moving image B: 2098”, and an added portion 2085 “added from moving image B: 2099” are displayed on a read-ahead portion 2045 and an untransferred portion 2050.

In the case of reproducing the deleted portion 2055, the moving image is reproduced as if there were no such portion. The details replaced portion 2060 and the details replaced portion 2065 are replaced with each other. The types of editing details (deletion, replacement, movement, and addition), and whether the moving image (three moving images A to C in FIG. 20) has been viewed may be displayed using different forms (colors, patterns, shapes, addition of text, or a combination thereof). For example, as illustrated in the example in FIG. 20, explanatory text may be added to each moving image portion and displayed. In addition, identical moving images may be displayed using the same color system, and the types of editing details may be displayed using different color densities.

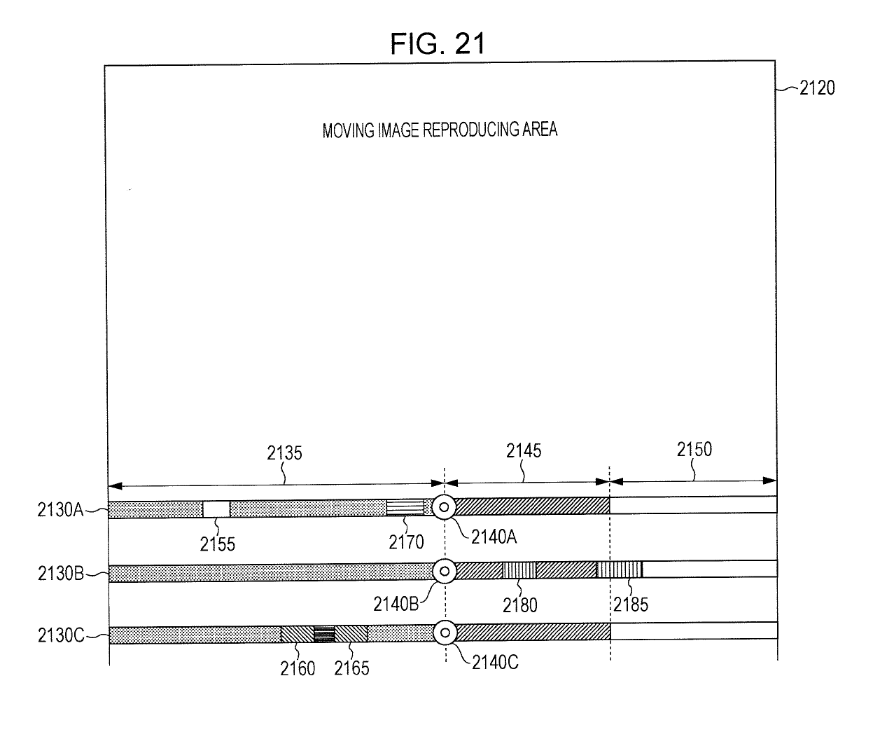

FIG. 21 is a diagram illustrating a display example according to the second exemplary embodiment (mainly the moving image difference representing module 190). This displays comparison between the multiple pre-editing moving images A to C and the edited moving image X. The edited moving image X is reproduced in a moving image reproducing area 2120. How the moving image X has changed from the moving image A is displayed on a reproduced amount displaying bar 2130A. How the moving image X has changed from the moving image B is displayed on a reproduced amount displaying bar 2130B. How the moving image X has changed from the moving image C is displayed on a reproduced amount displaying bar 2130C. In short, the reproduced amount displaying bar 2130 is prepared for each moving image to be compared, and, on that reproduced amount displaying bar 2130, an edited portion and its editing details in the moving image are displayed.

Each reproduced amount displaying bar 2130 displays a current position displaying FIG. 2140, like the example in FIG. 3. A “deleted portion 2155” and a “moved portion 2170” are displayed on a viewed portion 2135 of the reproduced amount displaying bar 2130A. An added portion 2180 and an added portion 2185 are displayed on a read-ahead portion 2145 and an untransferred portion 2150 of the reproduced amount displaying bar 2130B. A details replaced portion 2160 and a details replaced portion 2165 are displayed on a viewed portion 2135 of the reproduced amount displaying bar 2130C.

In the case of reproducing the deleted portion 2155, the moving image is reproduced as if there were no such portion. The details replaced portion 2160 and the details replaced portion 2165 are replaced with each other. The types of editing details (deletion, replacement, movement, and addition), and whether the moving image has been viewed may be displayed using different forms (colors, patterns, shapes, addition of text, or a combination thereof).

In the case where the number of reproduced amount displaying bars 2130 is greater than or equal to a predetermined number, the reproduced amount displaying bars 2130 may be combined with the display format in FIG. 20. For example, the reproduced amount displaying bars 2130 indicating the details of comparison with two or more moving images may have the display format of the reproduced amount displaying bar 2130 illustrated in the example in FIG. 20.

By performing comparison with multiple pre-editing moving images and displaying what kind of editing has been done on an edited moving image as has been described above, a viewer is able to grasp the relationship between each pre-editing moving image and the edited moving image, and the details of editing done on the edited moving image, before or while the edited moving image is reproduced.

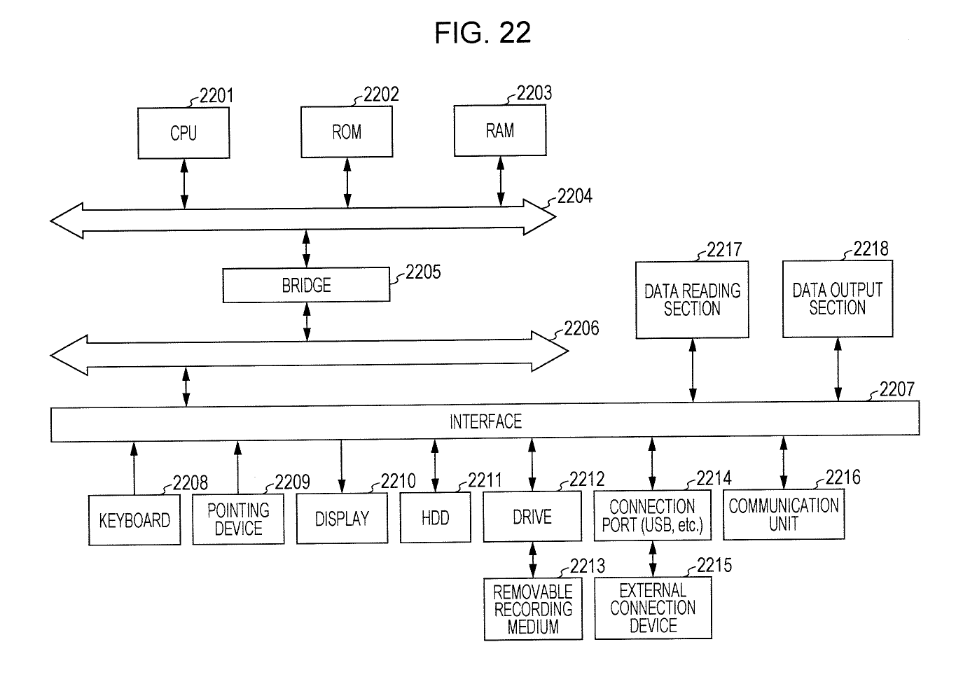

Referring to FIG. 22, an exemplary hardware configuration of an information processing apparatus according to an exemplary embodiment will be described. The configuration illustrated in FIG. 22 is configured by, for example, a personal computer (PC). FIG. 22 illustrates an exemplary hardware configuration including a data reading section 2217 such as a scanner, and a data output section 2218 such as a printer.

A central processing unit (CPU) 2201 is a controller that executes processing in accordance with a computer program describing the execution sequence of each of various modules described in the foregoing exemplary embodiments, including the moving image request receiving module 105, the moving image obtaining module 110, the moving image transmitting module 115, the moving image difference request receiving module 120, the moving image difference obtaining module 125, the moving image information obtaining module 130, the moving image information analyzing module 135, the moving image difference calculating module 140, the moving image difference transmitting module 145, the moving image history difference calculating module 1750, the moving image reproducing module 165, the moving image request transmitting module 170, the moving image receiving module 175, the moving image difference request transmitting module 180, the moving image difference receiving module 185, the moving image difference representing module 190, the moving image viewing history storage module 1793, and the moving image viewing history information obtaining module 1796.

A read-only memory (ROM) 2202 stores programs and calculation parameters used by the CPU 2201. A random-access memory (RAM) 2203 stores programs used in execution performed by the CPU 2201, and parameters that arbitrarily change in that execution. These units are connected to one another by a host bus 2204 including a CPU bus or the like.

The host bus 2204 is connected to an external bus 2206 such as a peripheral component interconnect/interface (PCI) bus via a bridge 2205.

A keyboard 2208 and a pointing device 2209 such as a mouse are input devices operated by an operator. A display 2210 is, for example, a liquid crystal display or a cathode ray tube (CRT), and displays various types of information and text as image information.

A hard disk drive (HDD) 2211 includes a hard disk (may be a flash memory), drives the hard disk, and records or reproduces programs executed by the CPU 2201 and information. The hard disk stores multiple items of pre-editing and edited moving image data, and items of data indicating the types and places of editing, and their editing details. Furthermore, the hard disk stores various other types of data and various computer programs.

A drive 2212 reads data or a program recorded on a removable recording medium 2213 such as a loaded magnetic disk, optical disk, magneto-optical disk, or semiconductor memory, and supplies the data or program to the RAM 2203 connected via an interface 2207, the external bus 2206, the bridge 2205, and the host bus 2204. The removable recording medium 2213 may also be used as a data recording area, like the hard disk.

A connection port 2214 is a port for connecting an external connection device 2215, and has a connection part such as Universal Serial Bus (USB) or the Institute of Electrical and Electronics Engineers, Inc. (IEEE) 1394. The connection port 2214 is connected to the interface 2207, and to the CPU 2201 and so forth via the external bus 2206, the bridge 2205, the host bus 2204, and so forth. A communication unit 2216 is connected to a communication line and executes data communication processing with the outside. The data reading section 2217 is, for example, a scanner, and executes reading of a document. The data output section 2218 is, for example, a printer, and executes output of document data.

Note that the hardware configuration of the information processing apparatus illustrated in FIG. 22 illustrates a single exemplary configuration, and that the exemplary embodiment is not limited to the configuration illustrated in FIG. 22 insofar as the configuration still enables execution of the modules described in the exemplary embodiment. For example, some modules may also be implemented with special-purpose hardware (such as an application-specific integrated circuit (ASIC), for example), and some modules may be configured to reside within an external system and be connected via a communication line. Furthermore, it may also be configured such that multiple instances of the system illustrated in FIG. 22 are connected to each other by a communication line and operate in conjunction with each other. Additionally, besides a personal computer in particular, an exemplary embodiment may also be incorporated into a device such as an mobile information/communication device (including devices such as a mobile phone, a smartphone, mobile equipment, and a wearable computer), information appliance, robot, photocopier, fax machine, scanner, printer, or multi-function device (that is, an image processing device having two or more from among scanning, printing, copying, and faxing functions).

Note that the described program may be provided stored in a recording medium, but the program may also be provided via a communication medium. In this case, a “computer-readable recording medium storing a program”, for example, may also be taken to be an exemplary embodiment of the present invention with respect to the described program.

A “computer-readable recording medium storing a program” refers to a computer-readable recording medium upon which a program is recorded, and which is used in order to install, execute, and distribute the program, for example.

The recording medium may be a Digital Versatile Disc (DVD), encompassing formats such as DVD-R, DVD-RW, and DVD-RAM defined by the DVD Forum and formats such as DVD+R and DVD+RW defined by DVD+RW Alliance, a compact disc (CD), encompassing formats such as read-only memory (CD-ROM), CD Recordable (CD-R), and CD Rewritable (CD-RW), a Blu-ray Disc (registered trademark), a magneto-optical (MO) disc, a flexible disk (FD), magnetic tape, a hard disk, read-only memory (ROM), electrically erasable and programmable read-only memory (EEPROM (registered trademark)), flash memory, random access memory (RAM), or a Secure Digital (SD) memory card, for example.

In addition, all or part of the above program may also be recorded to the recording medium and saved or distributed, for example. Also, all or part of the above program may be communicated by being transmitted using a transmission medium such as a wired or wireless communication network used in a local area network (LAN), a metropolitan area network (MAN), a wide area network (WAN), the Internet, an intranet, an extranet, or some combination thereof, or alternatively, by being modulated onto a carrier wave and propagated.

Furthermore, the above program may be part of another program, and may also be recorded to a recording medium together with other separate programs. The above program may also be recorded in a split manner across multiple recording media. The above program may also be recorded in a compressed, encrypted, or any other recoverable form.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiment were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a display controller that applies control to display an edited portion and its editing details in a moving image before or while the moving image is reproduced, in accordance with a difference obtained by comparing a pre-editing moving image and an edited moving image.

2. The information processing apparatus according to claim 1, wherein the display controller applies control, in each of frames of the moving image, to display an edited portion and its editing details in the moving image.

3. The information processing apparatus according to claim 2, wherein the frames are separated at scene transitions of the moving image or at places where video changes.

4. The information processing apparatus according to claim 1, wherein the display controller compares a pre-editing frame with each of a plurality of edited frames and, if there is a difference between the frames, applies control to display that editing has been done.

5. The information processing apparatus according to claim 1, wherein the editing details include at least one of deletion, replacement, movement, and addition.

6. The information processing apparatus according to claim 1, wherein, in a case where there is a plurality of pre-editing moving images, the display controller applies control to display which of the moving images has been edited to produce an edited portion, and to display its editing details.

7. The information processing apparatus according to claim 6, wherein the display controller compares a pre-editing moving image that has been viewed by a user in question with the edited moving image.

8. An information processing method comprising:
applying control to display an edited portion and its editing details in a moving image before or while the moving image is reproduced, in accordance with a difference obtained by comparing a pre-editing moving image and an edited moving image.

9. A non-transitory computer readable medium storing a program causing a computer to execute a process, the process comprising:
applying control to display an edited portion and its editing details in a moving image before or while the moving image is reproduced, in accordance with a difference obtained by comparing a pre-editing moving image and an edited moving image.
